(19) United States
(12) Patent Application Publication
(10) Pub. No.: US 2016/0315495 A1
(43) Pub. Date: Oct. 27, 2016

(54) BATTERY PACK

(71) Applicant: Samsung SDI Co., Ltd., Yongin-si, (KR)

(72) Inventor: Joo-Young Lee, Yongin-si (KR)

(21) Appl. No.: 14/933,381

(22) Filed: Nov. 5, 2015

(30) Foreign Application Priority Data
Apr. 22, 2015 (KR) 10-2015-0056738

(51) Int. Cl. H02J 7/02; H01M 2/02; H02J 50/12; H01M 10/46

(52) U.S. Cl. CPC H02J 7/025; H01M 10/46; H01M 2/0202; H02J 50/12; H01M 2220/30

(57) ABSTRACT

A battery pack is disclosed. In one aspect, the battery pack includes a battery cell having first and second surfaces opposing each other. The battery pack also includes a receiving coil configured to wirelessly receive power and charge the battery cell with the received power, wherein the receiving coil is formed over the first surface of the battery cell. The battery pack further includes a ground layer formed over the second surface of the battery cell.

### INCORPORATION BY REFERENCE TO ANY PRIORITY APPLICATIONS

This application claims priority to and the benefit of Korean Patent Application No. 10-2015-0056738 filed in the Korean Intellectual Property Office on Apr. 22, 2015, the entire contents of which are incorporated herein by reference.

### BACKGROUND

1. Field

The described technology generally relates to a battery pack.

2. Description of the Related Technology

In wireless charging technology, a wireless frequency signal is received to generate a direct current (DC) voltage for use in power supplies of systems or terminals.

Generally, wireless charging schemes are classified into either inductive coupling or magnetic resonance.

The inductive coupling scheme is a charging technology that employs a principle of electromagnetic induction in which a magnetic field is generated from a power transmitter coil and electricity is thus induced to a receiver coil by the generated magnetic field. The magnetic resonance scheme is a charging technology that employs a principle in which, after generating a magnetic field oscillating at a resonant frequency from a transmitter coil, energy is transferred to a receiver coil designed with the same resonant frequency.

The favorable characteristic of inductive coupling is that it has higher charging efficiency than magnetic resonance, but has a drawback in that wireless charging is performed only when the transmitter coil and the receiver coil are in close proximity to each other. The magnetic resonance scheme has a favorable characteristic in that it enables remote charging and one-to-many charging as opposed to the inductive coupling scheme, but has a drawback in that it has low charging efficiency due to low power transfer efficiency.

Recently, the number of portable terminals (e.g., smartphones) equipped with a near-field communication (NFC) module has increased. When such a terminal employs wireless charging, charging efficiency decreases due to interference between the NFC and the receiver coil used for wireless charging.

The above information disclosed in this Background section is only to enhance the understanding of the background of the inventive technology, and therefore it can contain information that does not constitute the prior art that is already known in this country to a person of ordinary skill in the art.

### SUMMARY OF CERTAIN INVENTIVE ASPECTS

One inventive aspect relates to a battery pack equipped with a wireless charging antenna and having enhanced charging efficiency in which interference of an NFC frequency signal for a receiving coil for wireless charging equipped in a battery pack can be blocked.

Another aspect is a battery module according to an exemplary embodiment that includes: a battery; a receiving coil for wireless charging that is disposed at a first surface of the battery; and a ground layer disposed at a second surface of the battery that is opposite to the first surface.

The receiving coil can be a receiving coil for wireless charging of a magnetic resonance scheme.

The ground layer can be a plate-shaped metal piece.

One end of the receiving coil can be electrically coupled to the ground layer.

One end of the receiving coil can be electrically coupled to the ground layer via a contact hole that penetrates a body of the battery.

One end of the receiving coil can be electrically coupled to the ground layer via a connecting bridge that crosses one lateral surface of the battery.

The battery module can further include an insulating layer for covering the receiving coil and the ground layer.

Another aspect is a battery pack, comprising: a battery cell having first and second surfaces opposing each other; a receiving coil configured to wirelessly receive power and charge the battery cell with the received power, wherein the receiving coil is formed over the first surface of the battery cell; and a ground layer formed over the second surface of the battery cell.

In the above battery pack, the receiving coil is configured to wirelessly receive the power via a magnetic resonance scheme. In the above battery pack, the ground layer includes a plate-shaped metal layer. In the above battery pack, a first end of the receiving coil is electrically coupled to the ground layer. In the above battery pack, the first end of the receiving coil is electrically coupled to the ground layer via a contact hole formed in the battery cell. In the above battery pack, the width of the contact hole is substantially the same as the thickness of the ground layer. The above battery pack further comprises a connector formed on the same layer as the receiving coil and formed over the contact hole, wherein the connector is configured to electrically connect the receiving coil to a conducting layer formed in the contact hole.

In the above battery pack, the first end of the receiving coil is electrically coupled to the ground layer via a connecting bridge surrounding a lateral surface of the battery. The above battery pack further comprises an insulating layer formed over the receiving coil and the ground layer. In the above battery pack, the ground layer covers the entire second surface of the battery.

Another aspect is a battery pack, comprising: a battery cell having first and second surfaces opposing each other; an antenna module layer formed on the first surface of the battery cell, wherein the antenna module layer comprises a receiving coil configured to wirelessly receive power and charge the battery cell with the received power; and a ground layer formed on the second surface of the battery cell, wherein the receiving coil is electrically connected to the ground layer via a contact hole penetrating a body of the battery cell or via a connecting bridge crossing one lateral surface of the battery cell.

The battery pack further comprises a first connector and a second connector formed in the antenna module layer, wherein the first and second connectors are adjacent to each other and located adjacent to a corner of the antenna module layer. In the above battery pack, the first connector is located closer to the corner of the antenna module layer than the second connector. In the above battery pack, the receiving coil has first and second ends, wherein the first and second ends of the receiving coil are respectively connected to the first and second connectors. In the above battery pack, a first end of the contact hole is connected to the first connector, and wherein a second end of the contact hole is connected to the ground layer. In the above battery pack, a first end of the connecting bridge is connected to the first connector, and wherein a second end of the connecting bridge is connected to the ground layer. In the above battery pack, the antenna module layer and the ground layer have substantially the same size as the first and second surfaces of the battery cell, respectively.

Another aspect is a battery pack, comprising: a case; a battery cell accommodated in the case and having first and second surfaces opposing each other; a near-field communication (NFC) antenna accommodated in the case and separated from the battery cell; an antenna module layer formed on the first surface of the battery cell, wherein the antenna module layer comprises a receiving coil configured to wirelessly receive power and charge the battery cell with the received power; and a ground layer formed on the second surface of the battery cell, wherein the antenna module layer and the ground layer have substantially the same size as the first and second surfaces of the battery cell, respectively, and wherein the receiving coil is electrically connected to the ground layer via a contact hole penetrating a body of the battery cell or via a connecting bridge crossing one lateral surface of the battery cell.

In the above battery pack, the NFC antenna is thicker than the receiving coil. The above battery pack further comprises a first connector and a second connector formed in the antenna module layer, wherein the first and second connectors are adjacent to each other and located adjacent to a corner of the antenna module layer, and wherein the first connector is located closer to the corner of the antenna module layer than the second connector.

According to at least one of the disclosed embodiments, interference of the NFC frequency signal for the receiving coil for wireless charging equipped in the battery module can be blocked, thereby enhancing wireless charging efficiency.

### BRIEF DESCRIPTION OF THE DRAWINGS

FIG. 1 is a perspective view of a battery module according to an exemplary embodiment.

FIG. 2 is a schematic cross-sectional view of a state in which the battery module of FIG. 1 is combined.

FIG. 3 is a drawing that illustrates how the battery module according to the exemplary embodiment receives wireless power.

FIG. 4 is a schematic cross-sectional view of an electronic device equipped with the battery module according to the exemplary embodiment.

FIG. 5 is a perspective view of a battery module according to another exemplary embodiment.

FIG. 6 is a schematic cross-sectional view of a state in which the battery module of FIG. 5 is combined.

FIG. 7 is a schematic cross-sectional view of an electronic device equipped with the battery module according to another exemplary embodiment.

### DETAILED DESCRIPTION OF CERTAIN INVENTIVE EMBODIMENTS

The described technology will be described more fully hereinafter with reference to the accompanying drawings, in which exemplary embodiments of the described technology are shown. As those skilled in the art would realize, the described embodiments can be modified in various different ways, all without departing from the spirit or scope of the described technology.

The drawings and description are to be regarded as illustrative in nature and not restrictive, and like reference numerals designate like elements throughout the specification.

Further, in the drawings, size and thickness of each element are arbitrarily illustrated for ease of description, and the described technology is not necessarily limited to such size and thickness illustrated in the drawings.

In the drawings, the thickness of layers, films, panels, regions, etc., are exaggerated for clarity. In the drawings, for ease of description, the thicknesses of some layers and regions are exaggerated. It will be understood that when an element such as a layer, film, region, or substrate is referred to as being “on” another element, it can be directly on the other element or intervening elements can also be present.

In addition, unless explicitly described to the contrary, the word “comprise” and variations such as “comprises” or “comprising” will be understood to imply the inclusion of stated elements but not the exclusion of any other elements. Further, in the specification, the word “on” means positioning on or below the object portion, and does not necessarily mean positioning on the upper side of the object portion based on a gravity direction. In this disclosure, the term “substantially” includes the meanings of completely, almost completely or to any significant degree under some applications and in accordance with those skilled in the art. The term “connected” can include an electrical connection.

In battery modules according to exemplary embodiments, a wireless charging receiving antenna can be combined to one surface of a battery. In addition, in order to prevent interference from another antenna, for example, a near-field communication (NFC) antenna, a ground layer is combined to the other surface of the battery that is opposite to the surface to which the wireless charging receiving antenna is attached.

A battery module according to an exemplary embodiment will now be described in detail with reference to the necessary drawings.

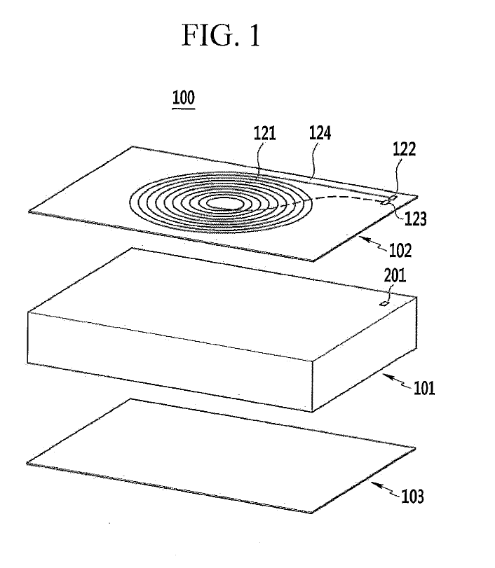

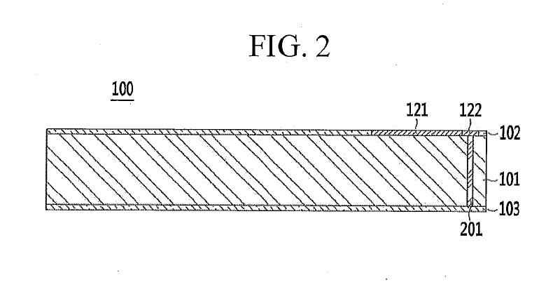

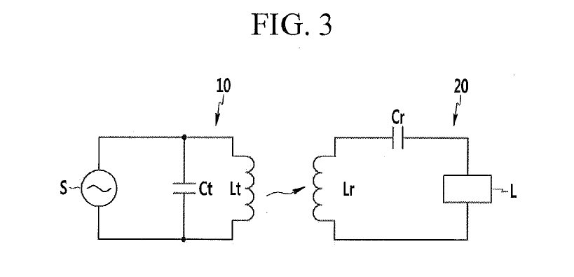

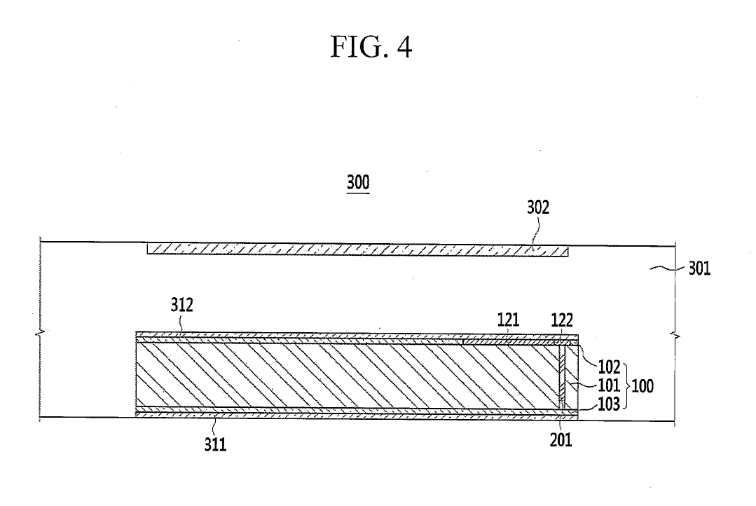

FIG. 1 is a perspective view of a battery module according to an exemplary embodiment. FIG. 2 is a schematic cross-sectional view of a state in which the battery module of FIG. 1 is combined. FIG. 3 is a drawing that illustrates how the battery module according to the exemplary embodiment receives wireless power. FIG. 4 is a schematic cross-sectional view of an electronic device equipped with the battery module according to the exemplary embodiment.

Referring to FIGS. 1 and 2, the battery module 100 according to the exemplary embodiment can include a battery module (or battery cell) 101, and a wireless charging antenna module 102 and a ground layer 103 that are attached to the battery module 101.

The battery module 101 internally includes a battery cell (not shown) and a protective circuit module (not shown), and can be implemented in a packaged form to protect the battery cell and the protective circuit module. The battery module 101 can further internally include a wireless charging circuit (not shown) for charging the battery cell with power received via the wireless charging antenna module 102.

The wireless charging antenna module 102 is combined to one surface of the battery module 101. The wireless charging antenna module 102 can be implemented as a film-based patch antenna. The wireless charging antenna module 102 is combined to one surface of the battery module 101 by an adhesion member such as an adhesive film or the like. The antenna module 102 and the ground layer 103 can have substantially the same size as the first and second surfaces of the battery cell 101, respectively.

The wireless charging antenna module 102 can receive, in a magnetic resonance scheme, wireless power transmitted from a wireless power transmission device (reference numeral 10 of FIG. 3).

A method for transmitting/receiving wireless power using the magnetic resonance scheme will now be described with reference to FIG. 3.

Referring to FIG. 3, in the method for transmitting/receiving wireless power using the magnetic resonance scheme, a magnetic field oscillating at a resonant frequency is generated from the wireless power transmission device 10. The generated magnetic field produces electromagnetic resonance in a wireless power receiving device 20, such that the produced resonance causes energy to be transferred from the wireless power transmission device 10 to the wireless power receiving device 20.

The wireless power transmission device 10 is a device for wirelessly transmitting power, and generates a magnetic field oscillating at a resonant frequency.

The wireless power transmission device 10, which is operated by using the magnetic resonance scheme, includes a power generator S, a transmitting coil Lt for generating a magnetic field from an AC power supplied from the power generator S, and a resonant circuit that is connected to the transmitting coil Lt to determine an oscillating frequency of the magnetic field. For example, in FIG. 3, the resonant circuit can be implemented by employing a transmitting capacitor Ct.

The wireless power receiving device 20 resonates with the magnetic field that is generated from the wireless power transmission device 10, and receives energy from the wireless power transmission device 10. The wireless power receiving device 20 supplies energy transferred from the wireless power transmission device 10 to power of a load L.

The wireless power receiving device 20, which is operated by using the magnetic resonance scheme, includes a receiving coil Lr and a resonant circuit for generating resonance in response to the magnetic field generated from the wireless power transmission device 10, e.g., a receiving capacitor Cr.

Referring back to FIG. 1, the wireless charging antenna module 102 includes a substrate 124 and an antenna-shaped receiving coil 121.

The substrate 124 can be a flexible substrate.

The receiving coil 121 corresponds to the receiving coil Lr in the wireless power receiving device 20 that is disclosed in FIG. 3. That is, the receiving coil 121 resonates with the magnetic field externally generated from the wireless power transmission device, and operates as a resonant antenna for receiving energy from the wireless power transmission device.

A metal wire is patterned on the substrate 124 to have an antenna shape, thereby preparing the receiving coil 121. On the other hand, in FIG. 1, the receiving coil 121 is exemplarily illustrated to be a circularly shaped antenna, but the exemplary embodiment is not limited thereto. For example, the receiving coil 121 can be modified to have various shapes such as oval, quadrangular, etc.

Each of opposite ends of the receiving coil 121 is electrically coupled to a plurality of connection portions 122 and 123. The connection portions 122 and 123 electrically couple opposite ends of the receiving coil 121 to a wireless charging circuit that is disposed inside or outside of the battery module 101. Accordingly, energy received from the external wireless power transmission device via the receiving coil 121 is transferred to the wireless charging circuit, and the battery cell (not shown) inside the battery module 101 can be charged by the wireless charging circuit.

Typically, when transmitting/receiving wireless power of the magnetic resonance scheme, a signal with a center frequency of about 6.78 MHz is used. Such a wireless charging frequency signal of the magnetic resonance scheme can cause interference with an NFC frequency signal.

Accordingly, when the battery module 100 according to the exemplary embodiment is equipped in a terminal with a NFC communication module, interference between the wireless charging frequency signal of the wireless charging antenna module 102 and the NFC frequency signal of the NFC communication module can occur. The interference between the wireless charging frequency signal and the NFC frequency signal can decrease power reception efficiency of the wireless charging antenna module 102, thereby deteriorating wifeless charging efficiency of the battery module 100.

Accordingly, in the exemplary embodiment, the ground layer 103 is combined to the other surface of the battery module 101 that is opposite to the surface thereof to which the wireless charging antenna module 102 is attached, thereby preventing the interference of the NFC frequency signal.

The ground layer 103 can be formed of a plate-shaped metal piece, such as a perfect electric conductor (PEC) or the like, to reflect the NFC frequency signal. The ground layer 103 can be attached to the battery module 101 by an adhesion member (not shown), such as an adhesive film or the like.

To operate as the wireless charging antenna, one end of the receiving coil 121 needs to be electrically coupled to the ground layer 103.

Referring to FIGS. 1 and 2, in order to electrically couple the receiving coil 121 and the ground layer 103 that are attached to the opposite surfaces of the battery module 101, a contact hole 201 can be formed to penetrate a body of the battery module 101.

By electrically coupling the connection portion 122, to which one end of the receiving coil 121 is connected, to the ground layer 103, the contact hole 201 penetrating the body of the battery module 101 can electrically couple one end of the receiving coil 121 to the ground layer 103.

When the battery module 100 with the structure described above is equipped in the terminal, the ground layer 103 is disposed to face the NFC communication antenna such that interference of the NFC communication antenna for the receiving coil 121 for wireless charging can be blocked.

A method for equipping a terminal with a battery module 100 according to an exemplary embodiment will now be described with reference to FIG. 4.

FIG. 4 is a schematic cross-sectional view of an electronic device equipped with the battery module according to the exemplary embodiment.

Referring to FIG. 4, a terminal 300 includes a case 301, and an NFC antenna 302 and a battery module 100 that are combined to the case 301.

The NFC antenna 302 and the battery module 100 are combined to respective different surfaces of the case 301 of the terminal 300. For example, the NFC antenna 302 and the battery module 100 are respectively combined to front and rear surfaces of the case 301 of the terminal 300.

When the battery module 100 is combined to the case 301 of the terminal 300, the ground layer 103 can be combined to face the case 301. Accordingly, the ground layer 103 of the battery module 100 and the NFC antenna 302 can be disposed opposite with respect to each other.

When the ground layer 103 that is formed of a plate-shaped metal piece is disposed opposite with respect to the NFC antenna 302, an NFC frequency signal emitted from the NFC antenna 302 can be reflected by the ground layer 103. Accordingly, since the NFC frequency signal transmitted to the wireless charging antenna module 102 is blocked by the ground layer 103, interference of the NFC frequency signal with the wireless charging frequency signal can be blocked.

As previously described, when the NFC frequency signal is blocked by the ground layer 103, a blocking effect for the NFC frequency signal can also become stronger as an area of the ground layer 103 increases. Accordingly, in the exemplary embodiment, in order to maximize the blocking effect of the NFC frequency signal, the ground layer 103 can be formed to cover one entire surface of the battery module 101.

In some embodiments, the wireless charging antenna module 102 and the ground layer 103 forming the battery module 100 are electrically insulated from the case 301 when being combined to the case 301 of the terminal 300. Accordingly, the battery module 100 can further include insulating layers 311 and 312 that are formed to cover the wireless charging antenna module 102 and the ground layer 103. The insulating layers 311 and 312 can be formed, as shown in FIG. 4, to partially cover the wireless charging antenna module 102 and the ground layer 103, or to cover the entire battery module 100.

In FIGS. 1 to 4, the receiving coil 121 and the ground layer 103 have been exemplarily illustrated to be electrically coupled via the contact hole 201 penetrating the body of the battery module 101, but the exemplary embodiments are not limited thereto.

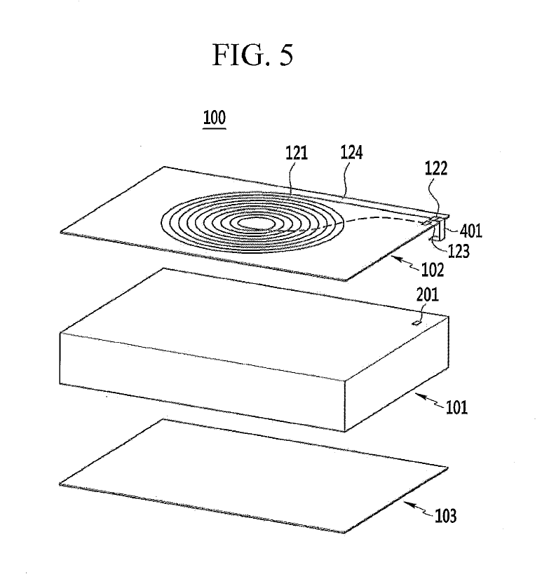

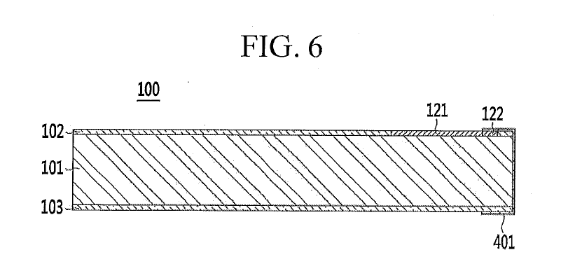

FIGS. 5 and 6 are drawings that illustrate a battery module according to another exemplary embodiment, exemplarily illustrating a case in which a receiving coil 121 for wireless charging and a ground layer 103 that are disposed at opposite surfaces of a battery module 101 are connected via a connecting bridge.

Referring to FIGS. 5 and 6, the battery module 100 according to the current exemplary embodiment includes a wireless charging antenna module 102 and a ground layer 103 that are disposed at opposite surfaces of the battery module 101.

The wireless charging antenna module 102 includes a substrate 124, and an antenna-shaped receiving coil 121.

The receiving coil 121 can be a resonant antenna with respective opposite ends electrically coupled to a plurality of connection portions 122 and 123. The connection portions 122 and 123 can electrically couple the opposite ends of the receiving coil 121 to a wireless charging circuit that is disposed inside or outside of the battery module 101.

According to the current exemplary embodiment, a connecting bridge 401 is used to electrically couple the receiving coil 121 to the ground layer 103.

The connecting bridge 401 can be formed in the shape of metal wires crossing one lateral surface of the battery module 101, such that their opposite ends are extended to respectively contact the connection portion 122 electrically coupled to the receiving coil 121 and the ground layer 103, thereby electrically connecting the coupling receiving coil 121 to the ground layer 103.

When the receiving coil 121 of the wireless charging antenna module 102 and the ground layer 103 are connected via the connecting bridge 401, the battery module 100 can further include a molding member (not shown) that encloses at least some of the battery module 101 to not expose the connecting bridge 401 to the outside.

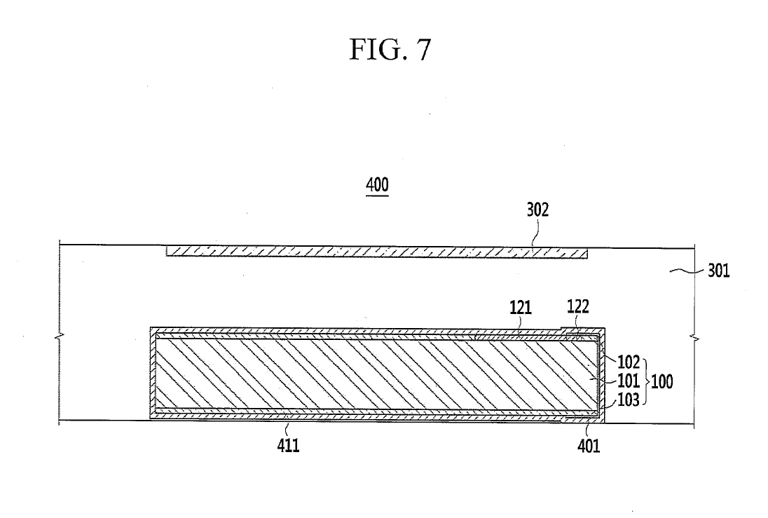

FIG. 7 is a schematic cross-sectional view of the terminal equipped with the battery module of FIG. 6.

Referring to FIG. 7, the NFC antenna 302 and the battery module 100 are combined to the different surfaces of the case 301 of the terminal 300. When the battery module 100 is combined to the case 301, the ground layer 103 of the battery module 100 and the NFC antenna 302 can be disposed to be opposite to each other.

Accordingly, since the NFC frequency signal transmitted to the wireless charging antenna module 102 disposed opposite with respect to the ground layer 103 is blocked by the ground layer 103, interference of the NFC frequency signal with the wireless charging frequency signal can be blocked.

On the other hand, when the battery module 100 is combined to the case 301 of the terminal 300, the receiving coil 121 and the ground layer 103 and the connecting bridge 401 electrically coupling them can be electrically insulated from the case 301. Accordingly, the battery module 100 can further include the insulating layer 411 that is formed to cover the wireless charging antenna module 102 and the ground layer 103. The insulating layer 411 can be formed to cover some of the battery module 100 including the receiving coil 121, the ground layer 103, and the connecting bridge 401, or can be formed to cover the entire battery module 100, as shown in FIG. 7.

According to at least one of the disclosed embodiments, in the battery modules, the ground layer that is formed of the plate-shaped metal piece is disposed at the other surface opposite to the surface where the wireless charging antenna module is disposed. Accordingly, when the battery module is combined to the terminal, the ground layer is disposed opposite with respect to the NFC communication antenna such that the NFC frequency signal can be reflected by the ground layer, thereby making it possible to block interference of the wireless charging frequency signal.

While the inventive technology has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A battery pack, comprising:
a battery cell having first and second surfaces opposing each other;
a receiving coil configured to wirelessly receive power and charge the battery cell with the received power, wherein the receiving coil is formed over the first surface of the battery cell; and
a ground layer formed over the second surface of the battery cell.

2. The battery pack of claim 1, wherein the receiving coil is configured to wirelessly receive the power via a magnetic resonance scheme.

3. The battery pack of claim 1, wherein the ground layer includes a plate-shaped metal layer.

4. The battery pack of claim 1, wherein a first end of the receiving coil is electrically coupled to the ground layer.

5. The battery pack of claim 4, wherein the first end of the receiving coil is electrically coupled to the ground layer via a contact hole formed in the battery cell.

6. The battery pack of claim 5, further comprising a connector formed on the same layer as the receiving coil and formed over the contact hole, wherein the connector is configured to electrically connect the receiving coil to a conducting layer formed in the contact hole.

7. The battery pack of claim 4, wherein the first end of the receiving coil is electrically coupled to the ground layer via a connecting bridge surrounding a lateral surface of the battery.

8. The battery pack of claim 1, further comprising an insulating layer formed over the receiving coil and the ground layer.

9. The battery pack of claim 1, wherein the ground layer covers the entire second surface of the battery.

10. A battery pack, comprising:
a battery cell having first and second surfaces opposing each other;
an antenna module layer formed on the first surface of the battery cell, wherein the antenna module layer comprises a receiving coil configured to wirelessly receive power and charge the battery cell with the received power; and
a ground layer formed on the second surface of the battery cell,
wherein the receiving coil is electrically connected to the ground layer via a contact hole penetrating a body of the battery cell or via a connecting bridge crossing one lateral surface of the battery cell.

11. The battery pack of claim 10, further comprising a first connector and a second connector formed in the antenna module layer, wherein the first and second connectors are adjacent to each other and located adjacent to a corner of the antenna module layer.

12. The battery pack of claim 11, wherein the receiving coil has first and second ends, wherein the first and second ends of the receiving coil are respectively connected to the first and second connectors.

13. The battery pack of claim 12, wherein a first end of the contact hole is connected to the first connector, and wherein a second end of the contact hole is connected to the ground layer.

14. The battery pack of claim 12, wherein a first end of the connecting bridge is connected to the first connector, and wherein a second end of the connecting bridge is connected to the ground layer.

15. The battery pack of claim 12, wherein the antenna module layer and the ground layer have substantially the same size as the first and second surfaces of the battery cell, respectively.

16. A terminal, comprising:
a case;
a battery cell accommodated in the case and having first and second surfaces opposing each other;
a near-field communication (NFC) antenna accommodated in the case and separated from the battery cell;
an antenna module layer formed on the first surface of the battery cell, wherein the antenna module layer comprises a receiving coil configured to wirelessly receive power and charge the battery cell with the received power; and
a ground layer formed on the second surface of the battery cell,
wherein the antenna module layer and the ground layer have substantially the same size as the first and second surfaces of the battery cell, respectively, and
wherein the receiving coil is electrically connected to the ground layer via a contact hole penetrating a body of the battery cell or via a connecting bridge crossing one lateral surface of the battery cell.

17. The terminal of claim 16, wherein the NFC antenna is thicker than the receiving coil.

18. The terminal of claim 17, further comprising a first connector and a second connector formed in the antenna module layer, wherein the first and second connectors are adjacent to each other and located adjacent to a corner of the antenna module layer.
